(19) United States
(12) Patent Application Publication
(10) Pub. No.: US 2007/0186989 A1
(43) Pub. Date: Aug. 16, 2007

(54) Flexible hose, in particular a charge air hose

(75) Inventors: Andreas Seyler, Grundau (DE); Gerhard Hummel, Birstein (DE)

Correspondence Address: BUCHANAN, INGERSOLL & ROONEY PC, POST OFFICE BOX 1404, ALEXANDRIA, VA, 22313-1404, US

(73) Assignee: VERITAS AG, Geinhausen (DE)

(21) Appl. No.: 10/591,692

(22) PCT Filed: Nov. 26, 2004
(86) PCT No.: PCT/EP04/13456

§ 371 Date: Nov. 8, 2006

(30) Foreign Application Priority Data
Mar. 5, 2004 (DE) 10 2004 010 861.7

(51) Int. Cl. F16L 11/00

(52) U.S. Cl. 138/126; 138/121; 428/36.91

(57) ABSTRACT

The invention relates to a flexible hose, in particular, a charge air hose, with at least three layers, whereby one layer is formed as a reinforcing layer and two layers comprise an elastomeric material, whereby one of the three layers contains acrylate rubber (ACM).

The invention relates to a flexible hose, in particular, a charge air hose, with at least three layers, whereby one layer is embodied as a reinforcing layer and the inner and outer layers comprise elastomeric material.

The use of charge air hoses for passing hot air from the engine to the air cooler has been known for a long time. The higher engine powers of modern turbo-powered vehicles demand in this respect increasingly stronger charge air pressures. This also involves higher charge air temperatures which put extreme stresses on the charge air hoses. The charge air temperatures are about 200° C. with an overpressure of 2.5 bar. Four-layer charge air hoses are known for these temperature ranges, comprising an inner layer of FPM, an intermediate layer and outer layer of silicone and a reinforcing layer, e.g. of an aramid fibre. The use of silicone is indispensable for applications in the high temperature range, because conventional rubber mixtures cannot withstand these temperatures and pressures.

Hoses manufactured from the materials quoted above are relatively cost-intensive to manufacture, because the materials used, in particular FPM, as well as silicone, are expensive. At the same time the use of four layers also increases the costs. In this connection four layers are however necessary to achieve a combination of all the desired properties, in particular because silicone must be protected from the aggressive film of fuel. Consequently, these hoses are used in particular in engines which also demand the higher temperature resistance.

At the same time hoses are also known which are suitable primarily for use in areas with lower temperature. In this connection the hoses with a three-layer structure have been well proven and comprise an inner layer of AEM (ethylene acrylate rubber), a reinforcing layer and an outer layer of AEM. Although these hoses are inexpensive to manufacture, they are however only suitable for the so-called cold range.

Once the highest temperatures for the hose suitable for the cold range are exceeded, it is therefore necessary to use the expensive hose, even if the temperature suitable for this hose is not reached.

Furthermore, a multilayer hose is known from EP 0 947 757 A2, whereby a middle layer is formed as a reinforcing layer and the inner and outer layers comprise an elastomeric material, whereby at least the inner surface of the hose, which is in contact with the medium, consists of a material comprising a mixture of FKM and ACM.

This type of hose does however depend on the adding of relatively high priced FKM and is therefore relatively expensive to manufacture; additionally, these types of hose designs are relatively rigid and attenuate the pulses and pressure peaks occurring in the charge air tract relatively badly.

The object of the invention is therefore to provide a hose which is suitable for temperature ranges below 200° C., is cost-effective to manufacture and exhibits good attenuation properties to pulses and pressure peaks occurring in the charge air tract.

The object is solved by a flexible hose, in particular a charge air hose with at least three layers whereby a middle layer is embodied as a reinforcing layer and the inner and outer layers comprise elastomeric material, the inner and outer layers of which consist of acrylate rubber (ACM) and the reinforcing layer of which comprises an open braiding, whereby the outer layer exhibits direct contact to the inner layer due to this open braiding.

The hose according to the invention is characterised by high resistance to the ambient atmosphere as well as the implemented materials in a temperature range up to 200° C., simultaneously offering adequate strength and durability and is economical to manufacture. The ACM material used is characterised by a particularly good ageing and ozone resistance. Additionally, the hose according to the invention exhibits good attenuation properties with respect to pulses and pressure peaks occurring in the charge air tract.

According to a preferred embodiment aramid fibres can be used as a reinforcing layer. In this respect the aramid fibres used give the hose an adequate strength with the simultaneous retention of the hose movement capability. Furthermore, aramid fibres have proven particularly suitable for suppressing pressure waves.

According to a preferred embodiment the reinforcing layer can contain Kevlar®. This material has proven particularly suitable in practice. Kevlar® is a product from Dupont consisting of poly(p-phenylenterephthalamid) which features good temperature resistance, good tensile strength and a good modulus of elasticity at a low density.

According to another preferred embodiment the reinforcing layer can contain Nomex®. Good hose prop-erties can also be obtained using Nomex®. Nomex® is also manufactured by Dupont and consists of poly(m-phenylenisophthalamid). This material is particularly suitable due to good thermal and flame-resistant properties.

Advantageously, the reinforcing layer can contain a combination of Kevlar® and Nomex®. In this way it is possible to combine the advantages of both materials without an additional layer being necessary.

According to another embodiment the reinforcing layer can be formed as a middle layer. In this way the reinforcing layer is protected on both sides against damage and against the influences of the ambient atmosphere.

Advantageously the reinforcing layer can be braided, lapped or knitted. All the methods quoted have been particularly proven in practice. In this connection, knitting stands out due to the low consumption of material in comparison to the other two methods quoted, which in turn is reflected in the total costs of the hose. According to a further preferred embodiment, the inner layer and the outer layer can contain ACM. ACM has in this connection proven to be a suitable material both for the inner and outer layers, well fulfilling the respective requirements placed on the relevant layer. Through the use of one and the same material for both layers, the manufacture is also simplified, because different raw materials do not need to be stored and also the coextrusion can be simplified.

A further preferred embodiment can be provided for in that the hose can be used from room temperature up to a maximum of 200° C.

Advantageously the flexible hose can be of a corrugated tube shape. In this way it is possible to further increase the flexibility of the hose. At the same time the hose can be used in the most varied applications.

In the following an embodiment of the invention is explained in more detail based on a drawing. The following are shown:

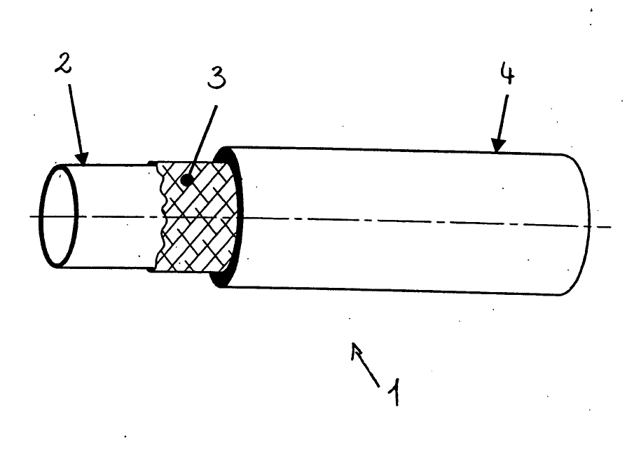

FIG. 1 a three dimensional view of a charge air hose.

The hose 1 illustrated in FIG. 1 consists of three layers arranged one on the other. In this respect the individual layers are each shown separately for better clarity—that is one section is exposed for each layer.

In detail the hose 1 comprises an inner layer 2, a reinforcing layer 3 and an outer layer 4. The inner layer 2 consists of ACM and is provided with a Kevlar® reinforcing layer lying directly on it. In this respect the reinforcing layer can completely enclose the inner layer 2, e.g. if it is woven, but it can also be formed as open braiding, so that the outer layer 3 applied to the reinforcing layer exhibits direct contact to the inner layer through the open braiding. This type of open braiding, e.g. knitted textile, can therefore contribute to better adhesion of the individual layers. The outer layer here also consists of ACM.

1-10. (canceled)

11. Flexible hose, in particular, a charge air hose, with at least three layers, wherein a middle layer is formed as a reinforcing layer and the inner and outer layers comprise an elastomeric material,
wherein
the inner and outer layers consist of acrylate rubber (ACM) and the reinforcing layer comprises an open braiding or knitted structure, wherein the outer layer exhibits direct contact to the inner layer due to this open braiding or knitted structure.

12. Flexible hose according to claim 1, wherein the reinforcing layer contains aramid fibres.

13. Flexible hose according to claim 1, wherein the reinforcing layer contains poly-(p-phenylenterephthalamid).

14. Flexible hose according to claim 1, wherein the reinforcing layer contains poly-(m-phenylenisophthalamid).

15. Flexible hose according to claim 1, wherein the reinforcing layer contains a combination of poly-(p-phenylenterephthalamid) and poly-(m-phenylenisophthalamid).

16. Flexible hose according to claim 1, wherein the reinforcing layer is braided, lapped or knitted.

17. Flexible hose according to claim 1, wherein the inner and outer layers contain ACM.

18. Flexible hose according to claim 1, wherein the hose can be used from room temperature up to a maximum of 200° C.

19. Flexible hose according to claim 1, wherein the hose is formed with a corrugated tube shape.
